(19) United States
(12) Patent Application Publication
(10) Pub. No.: US 2026/0328626 A1
(43) Pub. Date: Oct. 22, 2026

(54) FOOD THERMOMETER SYSTEM CAPABLE OF CLEARING CACHE DATA

(71) Applicants: Weilin Wang, Shenzhen (CN); Mian Luo, Shenzhen (CN)

(72) Inventors: Weilin Wang, Shenzhen (CN); Mian Luo, Shenzhen (CN)

(21) Appl. No.: 19/689,316

(22) Filed: May 27, 2026

(30) Foreign Application Priority Data
Apr. 27, 2026 (CN) 202620580034.0

(51) Int. Cl. G01K 7/02; G06F 12/0891

(52) U.S. Cl. CPC G01K 7/02; G06F 12/0891; G01K 2207/02; G01K 2215/00

(57) ABSTRACT

The present application provides a food thermometer system capable of clearing cache data, comprising a main control device and a probe. The probe is detachably connected to the main control device. When the probe is electrically connected to the main control device, the main control device charges the probe. When the electrical connection is disconnected, a power-on restart of the probe is triggered, and at least a portion of stored first cache data is cleared. Each time the probe is removed, the system triggers a power-on restart and initialization of a control module of the probe, automatically clears temporary temperature data in a memory, avoids memory exhaustion, and significantly extends the service life of the product.

### CROSS-REFERENCE TO RELATED APPLICATIONS

This application claims priority to Chinese Patent Application No. 202620580034.0, filed on Apr. 27, 2026, which is hereby incorporated by reference in its entirety.

### TECHNICAL FIELD

The present application relates to the technical field of temperature measurement, in particular to a probe-type thermometer system for monitoring temperature during food cooking, and more particularly to a food thermometer system capable of clearing cache data.

### BACKGROUND

In food cooking, particularly in scenarios such as roasting meat, barbecue, and low-temperature slow cooking, real-time monitoring of an internal temperature of food using a temperature probe has become an important means for ensuring food safety and taste. The United States Department of Agriculture (USDA) recommends that cooking temperatures of various meats reach specific values, for example, chicken needs to reach 74 degrees Celsius, and beef and lamb need to reach 63 degrees Celsius, which prompts more and more chefs and household users to rely on food thermometers for precise cooking.

An existing wireless food thermometer usually includes a probe insertable into food and a main control device for display and communication. The probe is internally provided with a battery, a control module, and a memory, and the main control device is used to charge the probe and to receive and display temperature data.

However, the existing technology is very prone to damage or failure during long-term use, mainly because a control module and a memory space inside the probe are limited. During long-term and repeated monitoring, the memory continuously accumulates temporarily stored temperature data. When the storage space is exhausted, the probe cannot continue to store new temperature data, resulting in device failure. Phenomena such as “inability to continue monitoring” and “crash” occur after the device is used for a period of time, and the root cause lies in this.

In addition, when the probe of an existing device is placed into the main control device for charging, the probe still remains in an operating state, causing unnecessary power consumption.

Therefore, there is an urgent need for an intelligent food thermometer capable of automatically managing storage space, improving battery power supply reliability, and reducing system power consumption, so as to solve the above technical problems.

### SUMMARY

The present application provides a food thermometer system capable of clearing cache data for solving cache and power consumption problems.

The present application provides a food thermometer system capable of clearing cache data. The food thermometer system comprises a main control device and a probe. The main control device comprises a discharging module configured to provide electrical energy. The probe is detachably connected to the main control device, the probe is electrically connected to the discharging module, the probe is configured to collect first cache data, and the probe comprises a first battery, a first control module, and a first power management module. The first control module comprises a first memory, and the first memory is configured to store the first cache data. The first power management module, the first control module, the first battery, and the discharging module are electrically connected. When the probe is electrically connected to the discharging module, the first power management module controls the first battery to be disconnected from the first control module, and controls the first battery to be connected to the discharging module, the discharging module being configured to charge the first battery. When the probe is disconnected from the discharging module, the first power management module controls the first battery to be connected to the first control module, the first battery being configured to supply power to the first control module, and the first control module is configured to clear at least a portion of the first cache data stored in the first memory.

Specifically, the first power management module comprises a first bus switch and a first power manager. The first power manager, the first bus switch, the first control module, and the discharging module are electrically connected, and the first bus switch is disposed between the first power manager and the first control module. When the first power manager detects that the probe is electrically connected to the discharging module, the first power manager controls the first bus switch to be opened, and the first battery is disconnected from the first control module. When the first power manager detects that the probe is disconnected from the discharging module, the first power manager controls the first bus switch to be closed, and the first battery is electrically connected to the first control module.

Specifically, the probe further comprises a rod body and a handle. The rod body is made of a thermally and electrically conductive material. The handle is made of a thermally insulating and electrically non-conductive material, and the handle is fixedly connected to the rod body. The handle and the rod body each have a hollow structure and together define a first accommodating space. The first memory, the first battery, the first control module, and the first power management module are accommodated in the first accommodating space.

Specifically, the rod body has an overall elongated rod-like structure, and the rod body comprises a first end portion and a second end portion. The handle is disposed between the first end portion and the second end portion. The first end portion, the second end portion, and the first battery are electrically connected, and the discharging module is configured to charge the first battery through the second end portion and the first end portion.

Specifically, the probe further comprises a temperature detection module accommodated in the first accommodating space. The temperature detection module, the first battery, and the first control module are electrically connected to one another, and the temperature detection module is configured to collect the first cache data.

Specifically, a side of the first end portion away from the handle is configured as a conical structure.

Specifically, the main control device further comprises a housing, a second battery, a second control module, and a second power management module. The housing comprises an upper housing and a lower housing detachably connected to each other. The upper housing and the lower housing together define a second accommodating space, and the upper housing is provided with a plurality of connection holes. The second power management module, the second control module, the second battery, and the discharging module are electrically connected to one another. The second power management module, the second control module, the second battery, and the discharging module are all received in the second accommodating space.

Specifically, the discharging module comprises a first electrode and a second electrode. The first electrode is disposed at one of the connection holes, the first electrode corresponds to the first end portion, and the first electrode passes through the one of the connection holes and is electrically connected to the first end portion. The second electrode is disposed at another one of the connection holes, the second electrode corresponds to the second end portion, and the second electrode passes through another one of the connection holes and is electrically connected to the second end portion. The first electrode, the second electrode, and the second battery are electrically connected to one another.

Specifically, the mounting portion is configured as a mounting groove formed by recessing from the upper housing in a direction toward the lower housing, and a shape of the mounting groove matches a shape of the probe.

Specifically, the first electrode is configured as a clip spring, and the second electrode is configured as a spring plate. When the probe is received in the mounting groove, the first electrode clamps the first end portion, such that the first electrode and the first end portion are electrically connected, and the second electrode abuts against the second end portion, such that the second electrode and the second end portion are electrically connected.

Specifically, the second electrode is disposed on one side of the mounting groove. A side of the second end portion away from the handle is configured as a cylindrical structure corresponding to the second electrode, and a portion of the second end portion abutting against the second electrode is configured as a planar structure.

Specifically, an extension groove is defined in a direction from the upper housing toward the lower housing, and the extension groove communicates with the mounting groove.

Specifically, the second control module comprises a second memory, and the second memory is configured to store second cache data. The discharging module further comprises a third electrode disposed at still another one of the connection holes and spaced apart from the first electrode. The third electrode corresponds to the first end portion, and the third electrode passes through the still another one of the connection holes and is electrically connected to the first end portion. When the probe is placed in the mounting groove, the first end portion simultaneously contacts the first electrode and the third electrode, the first electrode and the third electrode are electrically short-circuited through the rod body, and the second power management module cuts off an electrical connection between the second battery and the second control module. When the probe is removed from the mounting groove, the second power management module restores the electrical connection between the second battery and the second control module, and the second control module is configured to clear at least a portion of the second cache data stored in the second memory.

Specifically, the second power management module comprises a second bus switch and a second power manager. The second power manager, the second bus switch, the second control module, the discharging module, and the second battery are electrically connected, and the second bus switch is disposed between the second power manager and the second control module. When the second power manager detects that the first electrode and the third electrode are electrically short-circuited, the second power manager controls the second bus switch to be opened, and the second battery is disconnected from the second control module. When the second power manager detects that the first electrode and the third electrode are disconnected from each other, the second power manager controls the second bus switch to be closed, and the second battery is electrically connected to the second control module.

Specifically, a length of the first end portion is greater than a length of the second end portion.

Specifically, the third electrode is configured as a clip spring or a copper post.

Specifically, the food thermometer system further comprises an external mobile device electrically connected to the main control device. The probe further comprises a first communication module, and the first communication module is disposed in the first accommodating space and is electrically connected to the first control module. The main control device further comprises a second communication module, and the second communication module is disposed in the second accommodating space and is connected to the second control module. The second communication module is configured to receive temperature data transmitted by the first communication module and to send the temperature data to the second control module and to the external mobile device.

Specifically, the main control device further comprises a display module disposed at a position where the connection holes are located. The display module is electrically connected to the second control module, and the display module comprises a display screen and keys. The display screen is configured to display the temperature data and a battery level of the second battery. The second control module, the display screen, and the keys are electrically connected to one another.

Specifically, the main control device further comprises a plurality of magnetic elements, and the magnetic elements are mounted to the lower housing at intervals.

Specifically, a voltage receivable by the first control module in the probe is greater than 2.5 V, and when a voltage of the first battery is lower than 2.5 V, the first power management module also controls the first bus switch to be opened.

Compared with the existing technology, the food thermometer system capable of clearing cache data provided by the present application has the following beneficial effects:

First, cache data is automatically cleared, and the service life is extended. Each time the probe is removed, power restart and initialization of the control module of the probe are triggered, and temporary temperature data in the memory is automatically cleared, thereby fundamentally solving the problem of memory exhaustion caused by long-term use and significantly extending the effective service life of the product. A user does not need to perform any manual operation, and all processes are automated.

Second, battery reliability is improved, and the problem of deep discharge is solved. A voltage platform greater than 2.5 V is adopted, and a battery protection circuit is integrated, thereby effectively preventing a “deadlock” phenomenon in which the battery of the probe cannot be activated due to overdischarge. When the battery voltage is lower than 2.5 V, the discharging circuit is automatically cut off, and is automatically restored during charging, thereby improving factory reliability and user satisfaction of the product.

Third, system power consumption is reduced, and battery life is extended. When the probe is charged in place, the main control device can automatically cut off power supply to main functional circuits thereof, so as to realize standby with extremely low power consumption; the probe itself is also in a powered-off state during charging. This coordinated power-saving mechanism greatly extends the battery life of the main control device.

Fourth, use is convenient, and user experience is good. All processes such as cache data clearing, battery protection, and power-saving switching are automated. The user only needs to normally take out and place back the probe to enjoy complete intelligent management functions, without any additional operation.

### BRIEF DESCRIPTION OF THE DRAWINGS

For clearly describing the technical solutions in the embodiments of the present application, the drawings used in the description of the embodiments are briefly introduced below. Obviously, the drawings described below merely illustrate some embodiments of the present application. A person of ordinary skill in the art may obtain other drawings based on these drawings without creative effort. In the drawings:

FIG. 1 is a schematic perspective structural diagram of a food thermometer system capable of clearing cache data provided by the present application;

FIG. 2 is a structural block diagram of the food thermometer system capable of clearing cache data provided by the present application;

FIG. 3 is a schematic exploded perspective structural diagram of the food thermometer system capable of clearing cache data provided by the present application;

FIG. 4 is a schematic cross-sectional structural diagram of a probe in the system shown in FIG. 1;

FIG. 5 is a schematic cross-sectional structural diagram of a main control device in the system shown in FIG. 1;

FIG. 6 is a structural block diagram of a first power management module according to an embodiment of the present application;

FIG. 7 is a circuit connection topology diagram of the probe in the system shown in FIG. 1;

FIG. 8 is a circuit connection topology diagram of a portion related to the first power management module shown in FIG. 7;

FIG. 9 is a circuit connection topology diagram of the main control device in the system shown in FIG. 1;

FIG. 10 is a circuit connection topology diagram of a portion related to a second power management module shown in FIG. 9; and

FIG. 11 is a flowchart of a food thermometer control method provided by the present application.

### DESCRIPTION OF EMBODIMENTS

The technical solutions in the embodiments of the present application will be clearly and completely described below with reference to the accompanying drawings in the embodiments of the present application. Obviously, the described embodiments are merely some, rather than all, of the embodiments of the present application. All other embodiments obtained by a person of ordinary skill in the art based on the embodiments of the present application without creative effort shall fall within the protection scope of the present application.

It should be noted that all directional indications, such as up, down, left, right, front, and rear, in the embodiments of the present application are merely used to explain relative positional relationships, movement conditions, and the like between components in a specific posture, for example, as shown in the drawings. If the specific posture changes, the directional indications change accordingly.

In addition, descriptions such as “first” and “second” in the present application are merely used for descriptive purposes, and should not be understood as indicating or implying relative importance or implicitly indicating the number of the indicated technical features. Therefore, a feature defined by “first” or “second” may explicitly or implicitly include at least one such feature. In the description of the present application, “a plurality of” means at least two, such as two, three, or the like, unless otherwise expressly and specifically defined.

In the present application, unless otherwise expressly specified and defined, terms such as “connected” and “fixed” should be understood broadly. For example, “fixed” may refer to fixed connection, detachable connection, or integral formation; may refer to mechanical connection or electrical connection; may refer to direct connection or indirect connection through an intermediate medium; and may refer to internal communication between two elements or an interaction relationship between two elements, unless otherwise expressly defined. A person of ordinary skill in the art may understand the specific meanings of the above terms in the present application according to specific circumstances.

In addition, the technical solutions of the various embodiments of the present application may be combined with one another, provided that such combinations can be implemented by a person of ordinary skill in the art. When a combination of technical solutions is mutually contradictory or cannot be implemented, such a combination of technical solutions should be deemed not to exist and not to fall within the protection scope claimed by the present application.

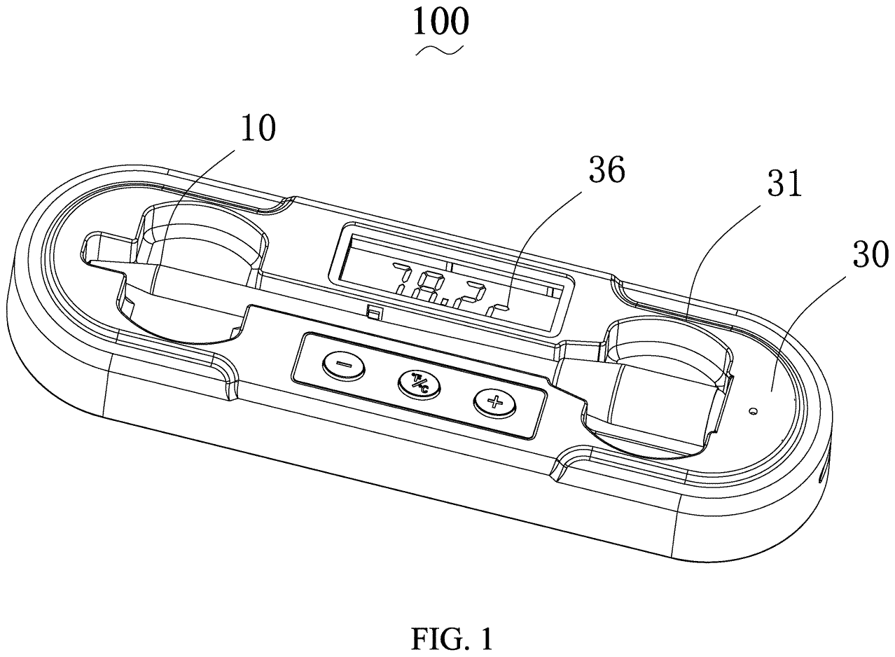

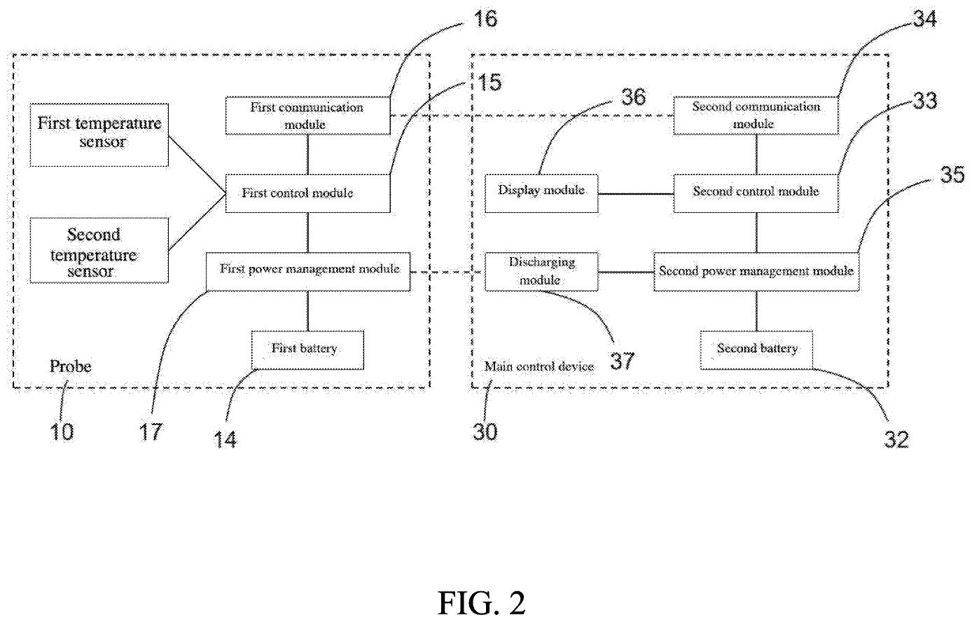

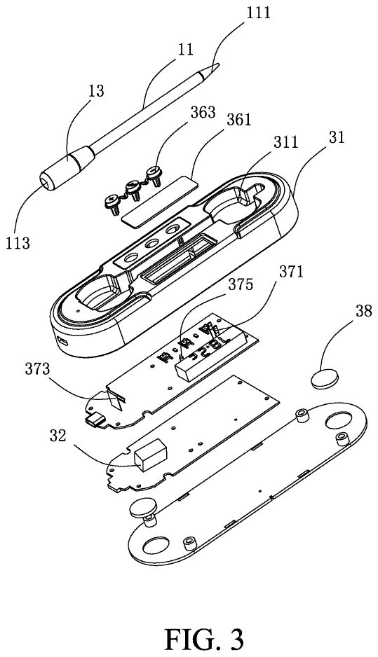

Referring to FIG. 1, FIG. 2, and FIG. 3, a food thermometer system 100 capable of clearing cache data mainly comprises a probe 10 and a main control device 30. The probe 10 is used to be inserted into food to measure a core temperature, and the main control device 30 is used to charge the probe 10 and to receive and display temperature data. The probe 10 comprises an elongated rod body 11 and a handle 13. The rod body 11 is made of a material having good electrical conductivity and thermal conductivity, preferably food-grade 304 stainless steel. The rod body 11 comprises a sharp first end portion 111 and an opposite second end portion 113.

The probe comprises a temperature detection module. The temperature detection module abuts against the first end portion and/or the second end portion, and is used to detect a temperature of food or an ambient temperature. In this embodiment, the temperature detection module comprises a first temperature sensor J3 and a second temperature sensor J4. The first end portion 111 is designed as a pointed conical shape, so as to facilitate insertion into food, and the first temperature sensor J3 is disposed inside the first end portion 111 in an abutting manner. The second end portion 113 has a cylindrical shape and is used to detect the ambient temperature, and the second temperature sensor J4 is disposed inside the second end portion 113 in an abutting manner. The design of dual temperature sensors enables the probe 10 to simultaneously monitor the core temperature of the food and the ambient temperature, thereby providing more comprehensive data reference for a cooking process. Certainly, in another embodiment, one temperature sensor may also be separately provided and disposed in an abutting manner at the first end portion 111 or the second end portion 113.

The handle 13 is made of a material that is electrically non-conductive and has good thermal insulation performance, such as ceramic or high-temperature-resistant plastic, and is fixed to a middle portion of the rod body 11 to separate the first end portion 111 from the second end portion 113, so as to prevent the first end portion 111 and the second end portion 113 from being directly short-circuited through the rod body 11, and to facilitate holding by a user and avoid scalding.

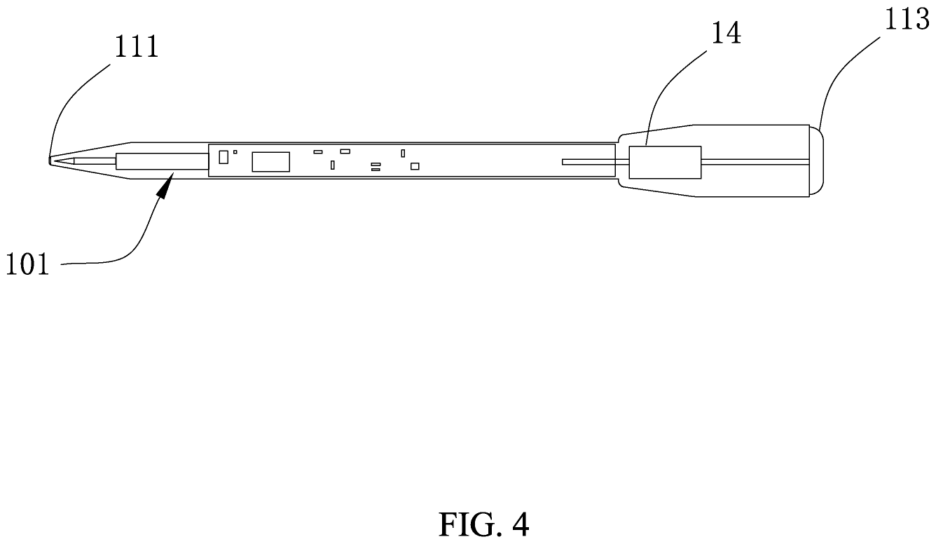

Referring also to FIG. 4, the rod body 11 and the handle 13 are internally hollow and each have a hollow structure, and together define a first accommodating space 101. A first battery 14, a first control module 15, a first communication module 16, and a first power management module 17 are accommodated in the first accommodating space 101.

The first battery 14 is preferably a rechargeable lithium-ion battery, and has a nominal voltage greater than 2.5 V, preferably 3.7 V, which provides a basis for adding battery protection. The first control module 15 may be a microcontroller, and a first memory 151 is integrated therein. The first memory 151 is used to store a firmware program, and to temporarily store, during operation of the device, temperature data collected by the first temperature sensor J3 and the second temperature sensor J4. The first communication module 16 is preferably a low-power Bluetooth module. The first end portion 111 and the second end portion 113 are respectively electrically connected to positive and negative electrodes of the first battery 14. Since the rod body is made of a thermally and electrically conductive material, the corresponding first end portion 111 and second end portion 113 can both be used for thermal conduction and electrical conduction. Temperature detection is realized by causing the temperature detection module to abut against or be close to the rod body. Meanwhile, the first end portion 111 and the second end portion 113 are electrically connected to the positive and negative electrodes of the first battery 14, and, based on isolation by the handle 13, the probe 10 itself forms a rechargeable plug structure. By detachably connecting the probe 10 to the main control device 30, the main control device 30 can charge the probe 10.

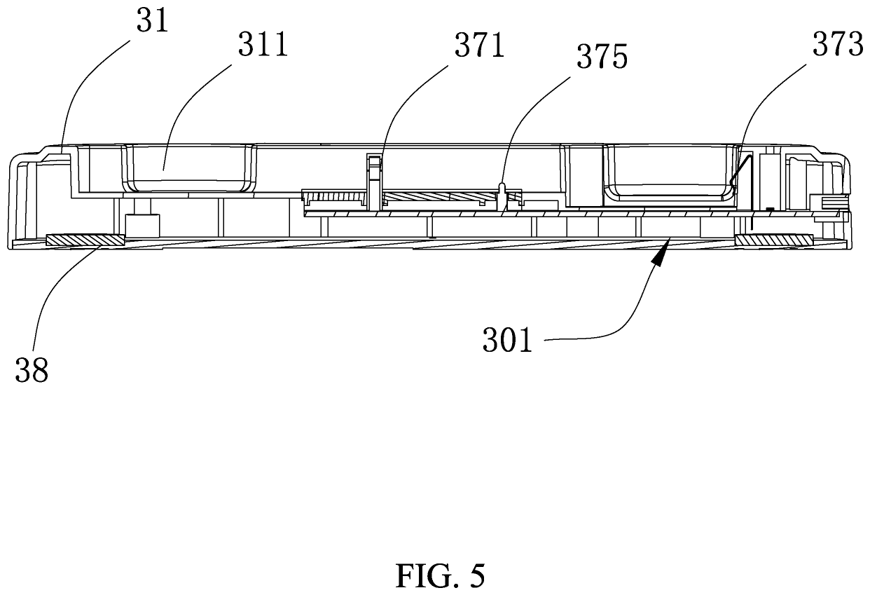

Referring further to FIG. 2, FIG. 3, and FIG. 5, the main control device 30 comprises a housing 31. The housing 31 comprises an upper housing and a lower housing detachably connected to each other, and the upper housing and the lower housing together define a second accommodating space 301. The upper housing and the lower housing are merely relative concepts and do not limit specific orientations. In this embodiment, the upper housing is provided with a plurality of connection holes, so as to facilitate fitting connection between the second accommodating space 301 and an exterior of the housing 31. A mounting portion 311 is provided on a surface of the housing 31, that is, the corresponding upper housing is provided with the mounting portion 311. The mounting portion 311 is configured as a mounting groove formed by recessing from the upper housing in a direction toward the lower housing, and a shape of the mounting groove matches a shape of the probe 10, so as to accommodate and fix the probe 10. The second accommodating space 301 accommodates a second battery 32, a second control module 33, a second communication module 34, a second power management module 35, a display module 36, and a discharging module 37.

It should be noted that the mounting portion 311 may be provided in various manners. In this embodiment, the mounting portion 311 is configured as a mounting groove formed by recessing from the upper housing in the direction toward the lower housing. This arrangement manner takes an outermost surface of the upper housing as a reference and recesses toward modules in the second accommodating space 301, thereby compressing the second accommodating space 301. Certainly, in another embodiment, the mounting portion 311 may not need to be recessed inward, and a protruding structure capable of clamping or snap-fitting mounting may be directly provided on the surface of the upper housing, or a certain region may protrude outward from the surface of the upper housing to form a mounting structure for accommodating the probe 10, which will not be described in detail herein.

In this embodiment, the housing 31 is provided with an extension groove corresponding to the mounting groove. Specifically, the extension groove is defined in a direction from the upper housing toward the lower housing, and the extension groove communicates with the mounting groove. It should be noted that the mounting groove is a groove-shaped structure matching the shape of the probe 10, and also has an overall elongated groove-shaped structure. On this basis, the extension groove is a groove-shaped structure extending toward two sides. A specific extension size and depth are not limited herein, but the extension groove needs to communicate with the mounting groove, thereby facilitating a user to remove the probe 10 from the main control device 30. Certainly, in another embodiment, the extension groove may be omitted. For example, by providing a press-type spring structure at one end of the mounting groove, the user may press by hand to pop up the probe 10, thereby also removing the probe 10. Alternatively, when the mounting portion 311 is not an inwardly recessed groove-shaped structure, but is provided as a clamping or snap-fitting structure on the surface of the upper housing, or is provided by arranging a protruding region outward from the surface of the housing 31, the extension groove may also be omitted, and the user may directly take the probe 10 based on the protruding portion.

The second battery 32 may be a detachable battery or an internal rechargeable lithium-ion battery. The second control module 33 likewise comprises a second memory 331. The second communication module 34 matches the first communication module 16, and both are low-power Bluetooth modules. The display module 36 comprises a display screen 361 and a plurality of control keys 363. The discharging module 37 is, as a whole, disposed close to the mounting portion 311 and is configured to form an electrical connection with the probe 10 placed therein.

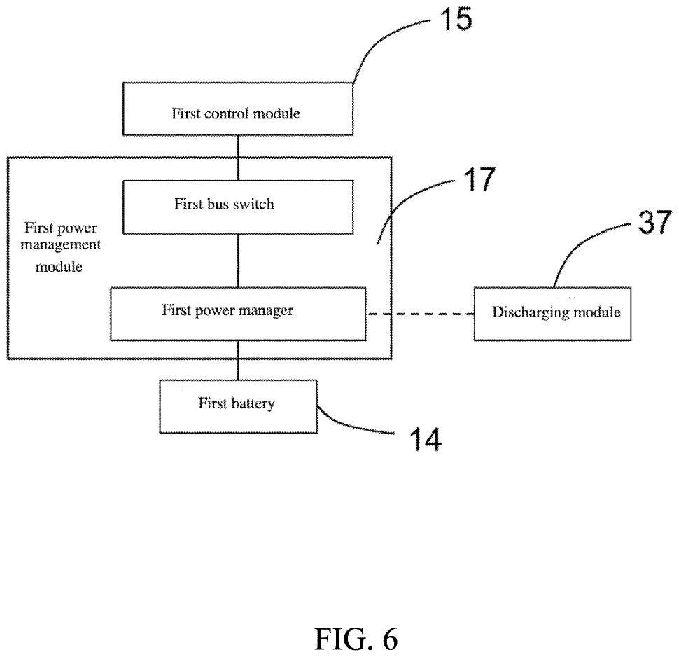

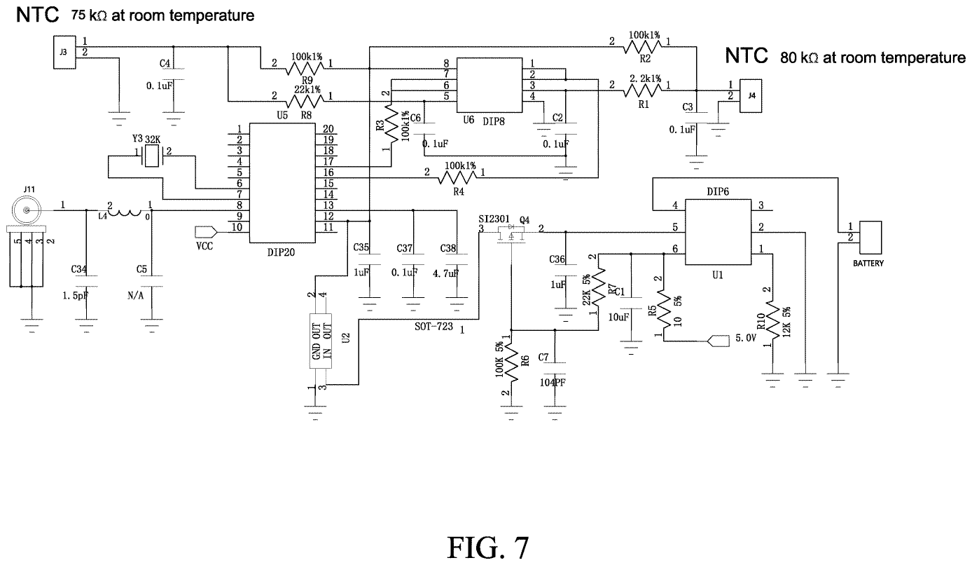

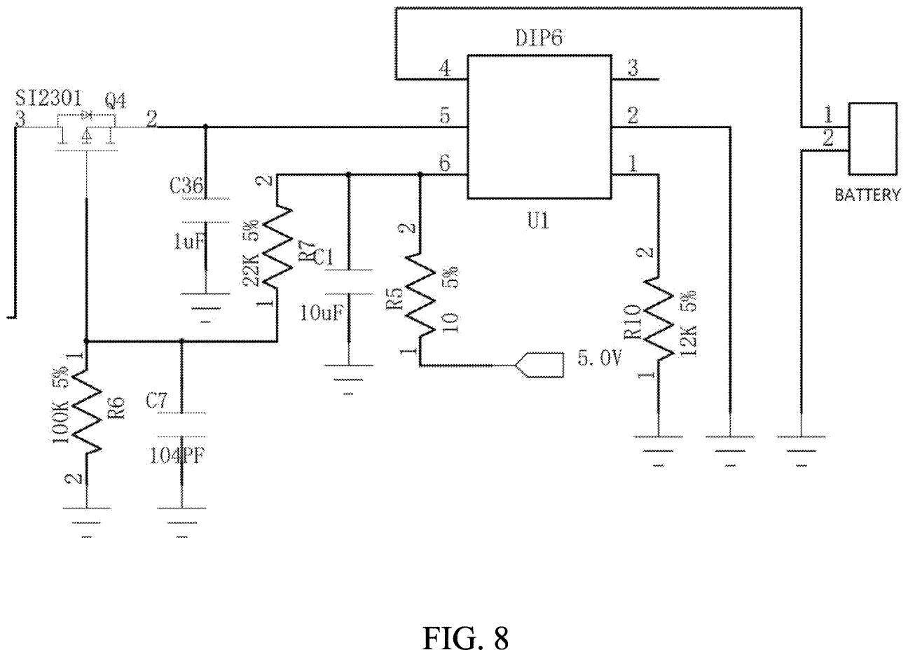

Referring also to FIG. 6, FIG. 7, and FIG. 8, the first power management module 17 comprises a first bus switch Q4 and a first power manager U1. The first power manager U1 is electrically connected to the discharging module 37 and is connected to the first control module 15 through the first bus switch Q4. When the first power manager U1 detects that the probe 10 is electrically connected to the main control device 30, the first power manager U1 controls the first bus switch Q4 to be opened, and the first battery 14 is disconnected from the first control module 15. When the first power manager U1 detects that the probe 10 is disconnected from the main control device 30, the first power manager U1 controls the first bus switch Q4 to be closed, and the first battery 14 is electrically connected to the first control module 15.

The first power management module 17 may control a power supply path between the first battery 14 and the first control module 15 in various manners, for example, by directly using an integrated chip or by providing a management circuit composed of a plurality of electronic components including switches. In the manner directly using an integrated chip, a PMIC having a power path management function may be selected. When external power supply is detected, the chip internally automatically cuts off output of the battery to a load, and instead an external power source supplies power to the load and charges the battery. When the external power source is removed, the chip internally automatically switches back to battery power supply. In a multi-component solution, a MOSFET may be used as a switch, and a comparator may be used to monitor a voltage change so as to control turning on and turning off of the MOSFET.

In this embodiment, the first bus switch Q4 cooperates with the integrated first power manager U1, so that integrated arrangement can be completed as much as possible while power supply path control is realized, thereby facilitating circuit board layout and saving product costs. The first power manager U1 adopts a dedicated logic control IC, such as a logic gate, a comparator, or a dedicated power management chip, and a quiescent operating current thereof may be at a microampere level or even a nanoampere level. When the probe 10 is placed into the main control device 30 for charging, the first power manager U1 still remains in a standby monitoring state, but power consumption thereof is extremely low and almost negligible. By contrast, if a control circuit is built using discrete components, quiescent power consumption may be higher by several orders of magnitude. Control logic, voltage detection, and a driving circuit are integrated in a small package, such as SOT23-5 or DFN, and cooperate with a single MOSFET, so that an overall board area is much smaller than that of a solution using a plurality of discrete components. Moreover, this solution naturally supports cooperative operation with a battery protection circuit. When a voltage of the first battery 14 is lower than a protection threshold, the protection circuit may also control the first bus switch to be opened, thereby realizing dual protection.

For the first power manager U1, there are various arrangement manners. In a specific embodiment, the first power manager U1 may be implemented by using a voltage detection IC. Exemplarily, an XC61C-series voltage detector is selected, and a detection threshold thereof is set to 2.5 V. A VCC pin of the voltage detector is connected to a detection terminal of the discharging module, and an OUT pin is connected to a control terminal of the first bus switch. When the probe is placed into the main control device, a voltage at the detection terminal is 3.7 V, which is higher than the detection threshold of 2.5 V, and the OUT pin of the voltage detector outputs a low level to control the first bus switch to be opened. When the probe is removed from the main control device, the voltage at the detection terminal drops to 0 V, which is lower than the detection threshold, and the OUT pin outputs a high level to control the first bus switch to be closed. This solution requires very few peripheral components, and quiescent power consumption may be as low as less than 1 μA.

In another embodiment, the first power manager U1 may be implemented by using a micropower comparator in cooperation with a reference voltage source. A MAX9063 comparator is selected, a positive input terminal thereof is connected to the detection terminal through a resistor voltage divider network, and a negative input terminal thereof is connected to a 2.5 V reference voltage. When the detection voltage is higher than 2.5 V, the comparator outputs a low level. When the detection voltage is lower than 2.5 V, the comparator outputs a high level. This solution has higher threshold accuracy and stronger anti-interference capability. Certainly, in another embodiment, a logic function of the first power manager U1 may be implemented by a logic gate circuit. A 74LVC1G00 NAND gate is used, and two input terminals thereof are shorted together and connected to the detection terminal. By using threshold characteristics of an input level of the logic gate, a low level is output when the detection voltage is higher than a threshold, and a high level is output when the detection voltage is lower than the threshold. This solution has the simplest structure and the lowest cost.

Referring further to FIG. 3 and FIG. 5, the discharging module 37 comprises three independent metal electrodes, namely a first electrode 371, a second electrode 373, and a third electrode 375. The electrodes are disposed at the connection holes of the upper housing and pass through the upper housing. One end of each electrode is exposed at a surface of the mounting portion 311, and the other end is connected to circuits such as the second power management module 35 and the second battery 32 in the second accommodating space 301.

A position of the first electrode 371 corresponds to the first end portion 111 of the probe 10. Positions of the second electrode 373 and the third electrode 375 correspond to a middle portion of the rod body 11 and are close to the second end portion 113. The first electrode 371 may adopt an elastic clip structure, which can both conduct electricity and clamp the probe 10. The third electrode 375 may be an elastic copper post or a clip spring.

Here, a circuit setting principle of the first end portion 111, the second end portion 113, the first electrode 371, and the second electrode 373 is described. The first end portion 111 and the second end portion 113 respectively correspond to positive and negative electrodes of the first battery 14, and the first electrode 371 and the second electrode 373 respectively correspond to positive and negative electrodes of the second battery 32. To realize a charging function of the second battery 32 for the first battery 14, the above corresponding relationships need to remain consistent. In this embodiment, the first end portion 111 corresponds to a negative electrode of the first battery 14, and the first electrode 371 corresponds to a negative electrode of the second battery 32. Correspondingly, the second end portion 113 corresponds to a positive electrode of the first battery 14, and the second electrode 373 corresponds to a positive electrode of the second battery 32, so that charging is realized when the first electrode 371 abuts against the first end portion 111 and the second electrode 373 abuts against the second end portion 113. Certainly, in other embodiments, reverse arrangement may also be performed, which will not be described in detail herein.

When the probe 10 is correctly placed in the mounting portion 311, the second end portion 113 of the probe 10 contacts the second electrode 373, and the first end portion 111 of the probe 10 simultaneously contacts the first electrode 371 and the third electrode 375. Since the entire rod body 11 is conductive, the first electrode 371 and the third electrode 375 are short-circuited through the rod body 11 at this time. Meanwhile, a charging circuit of the first battery 14 is established, that is, a positive electrode of the second battery 32 reaches a positive electrode of the first battery 14 through the second electrode 373 and the second end portion 113 of the rod body 11, and returns to a negative electrode of the second battery 32 through a negative electrode of the first battery 14, the first end portion 111, and the first electrode 371, thereby forming a complete circuit.

When the probe 10 is mounted in the mounting portion 311, the first electrode 371 clamps the first end portion 111, and the second end portion 113 abuts against the second electrode 373. The design of the clip spring and the spring plate provides reliable mechanical contact and electrical connection, and facilitates a user to take out and place the probe 10. In addition, the extension groove provided in the mounting portion 311 relative to the probe 10 provides an operation space for the user to take out the probe 10 with fingers, thereby improving use convenience.

When the probe 10 is removed, contact between the probe 10 and each electrode is completely disconnected. An input terminal of the first power manager U1 loses voltage. According to internal logic thereof, the first power manager U1 controls the first bus switch Q4 to be closed, and the first battery 14 starts to supply power to the first control module 15. This is a power-on restart process. The first control module 15 starts from a reset state, and a first step of a firmware program thereof is to perform initialization. The initialization program includes an instruction for clearing at least a portion of the first cache data stored in the first memory 151. The first cache data refers to temperature data detected by the temperature detection module, and the clearing instruction may be configured to clear a portion of the first cache data or all of the first cache data. When the clearing instruction is configured to clear all of the first cache data, in the current use cycle, the first memory 151 is clean and has all available space. Certainly, deletion of a portion of the first cache data may also be configured, for example, only temperature data detected in a previous cycle is retained each time for viewing. This manner can also ensure available space of the first memory 151 and ensure continuous use of the probe 10.

With the above configuration, each time the probe 10 is removed from the main control device 30 for use, the first control module 15 of the probe 10 undergoes a complete power-off restart process. In a restart initialization program, the temperature data temporarily stored in the first memory 151 is automatically cleared, thereby ensuring that the first memory 151 has sufficient available space each time it is used, and fundamentally solving the problem of memory exhaustion caused by long-term use.

Similarly, when the probe 10 is placed back, the first bus switch Q4 is opened, and the first control module 15 is completely powered off. When the probe 10 is removed again, a new and clean restart is triggered again.

It should be noted that the positions of the first electrode 371, the second electrode 373, and the third electrode 375 may be provided in various manners. In this embodiment, the first electrode 371 is configured as a clip spring, and the second electrode 373 is configured as a spring plate. The second electrode 373 may be disposed on one side of the mounting groove. To adapt to the mounting portion 311 of the main control device 30, a side of the second end portion 113 away from the handle 13 may be configured as a cylindrical structure corresponding to the second electrode 373, and a portion of the second end portion 113 abutting against the second electrode 373 is configured as a planar structure, thereby ensuring that the electrical connection between the probe 10 and the discharging module 37 is sufficiently stable. In addition, in order to avoid accidental contact, the first electrode 371 and the third electrode 375 are spaced apart from each other as far as possible, so the first end portion 111 is not a relatively short point-like portion, but a portion having a relatively long section. The first end portion 111 and the second end portion 113 in the present application are relative definitions. With the handle 13 as a boundary of the rod body, entire rod body portions connected to two ends of the handle 13 are respectively defined as the first end portion 111 and the second end portion 113. Moreover, a length of the first end portion 111 needs to be greater than a length of the second end portion 113, thereby facilitating the position arrangement of the first electrode 371, the second electrode 373, and the third electrode 375, facilitating connection between the first electrode 371, the second electrode 373, and the third electrode 375 and the rod body, and preventing mutual interference.

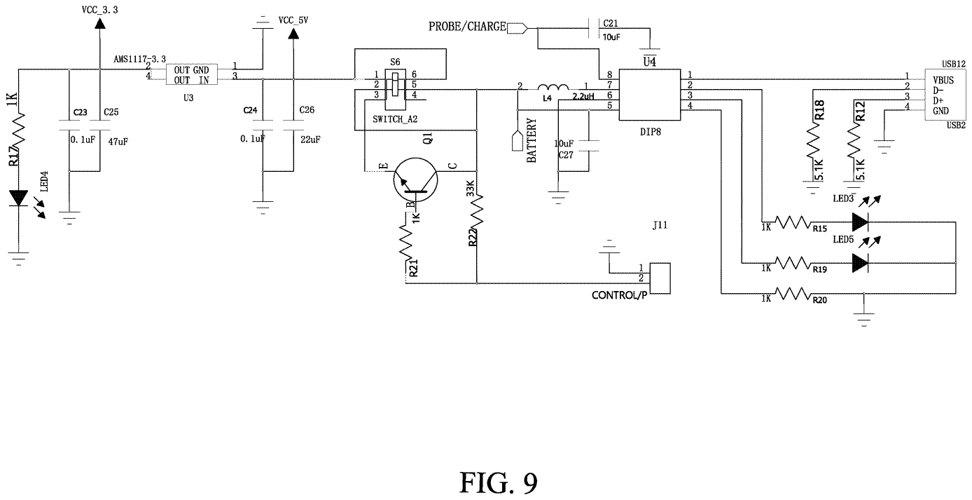

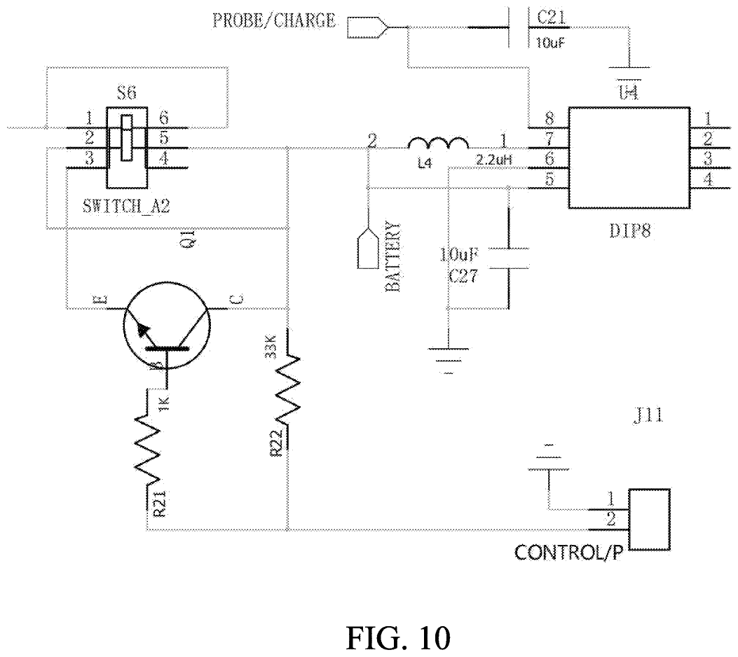

Referring also to FIG. 2, FIG. 5, FIG. 9, and FIG. 10, the second power management module 35 is configured to detect a short-circuit state between the first electrode 371 and the third electrode 375. When the probe 10 is placed in, the second power management module 35 detects that the two electrodes are short-circuited, that is, determines that the probe 10 is in place, and then controls an internal second bus switch S6 to be opened, thereby cutting off power supply from the second battery 32 to main functional circuits such as the second control module 33 and the display module 36, so that the main control device 30 enters a deep sleep mode.

When the probe 10 is taken out, the short-circuit state disappears, the second power management module 35 closes the second bus switch S6, the second battery 32 restores power supply to the second control module 33, and the main control device 30 starts. The second control module 33 also executes an initialization program, clears second cache data in the second memory 331, and starts to establish a connection with the probe 10 through the second communication module 34 to receive the first cache data transmitted by the probe 10. The second cache data and the first cache data are both temperature data detected by the temperature detection module. The second control module clears at least a portion of the second cache data stored in the second memory. The clearing manner may refer to the processing manner of the first cache data, and may similarly clear all data or clear a portion of the data, thereby ensuring available space of the second memory and ensuring continuous use of the main control device 30.

This configuration realizes automatic power saving and cache data clearing of the main control device 30. When the probe 10 is placed in for charging, the main control device 30 automatically cuts off power supply to its main functional circuits and enters a deep standby mode, thereby greatly saving electrical energy. When the probe 10 is taken out for use, the main control device 30 automatically restores power supply and restarts to clear cache data, thereby ensuring sufficient storage space for each use.

It should be noted that the second power management module 35 in the main control device 30 and the first power management module 17 in the probe 10 may be provided in the same manner or in different manners. In this embodiment, the two are provided in the same manner. The second power management module 35 is likewise provided with a second bus switch S6, and cooperates with a second power manager (not shown) to realize conduction control between the second battery 32 and the second control module 33. Certainly, in another embodiment, the first power management module 17 may also not cut off the main power supply, but only send a dedicated reset signal to the first control module 15. After receiving the signal, the first control module 15 triggers an interrupt service routine, and the routine is responsible for clearing the first memory 151. An advantage of this solution lies in that the first control module 15 can maintain certain key states while only clearing volatile temperature cache. The second power management module 35 may likewise be provided in the same manner as the first power management module 17. The specific arrangement manner of the second power management module 35 and the arrangement manner of an internal second power manager will not be described in detail herein.

The third electrode 375 may be configured as a clip spring or a copper post. The clip spring provides a better fixing effect, while the copper post provides a simpler structure. Certainly, the main control device 30 may also omit the third electrode 375, and instead an independent microswitch or Hall sensor may be provided in the mounting portion 311. When the probe 10 is placed in, the microswitch is mechanically triggered, or a magnet on the probe 10 triggers the Hall sensor, thereby generating an electrical signal for the power management module to determine an in-place state of the probe 10. This can avoid providing an additional electrical contact point on the rod body 11 and simplify the structure, but increases mechanical or magnetic elements.

Referring further to FIG. 2 and FIG. 3, wireless data transmission is performed between the probe 10 and the main control device 30 through low-power Bluetooth modules. The first control module 15 sends temperature data collected by the first temperature sensor J3 and the second temperature sensor J4 to the second communication module 34 through the first communication module 16, and the second control module 33 displays the temperature data on the display screen 361 in real time after receiving the temperature data. As alternatives, the first communication module 16 and the second communication module 34 may also employ wireless communication technologies such as Zigbee, LoRa, ANT+, or a 5G protocol.

The display screen 361 may simultaneously display information such as a currently detected food temperature, a preset target temperature, and a battery level of the second battery 32. A user may switch display modes through the keys 363, for example, switch between degrees Celsius and degrees Fahrenheit, set a temperature alarm threshold, and the like.

To facilitate placement of the main control device 30, the main control device 30 may further be provided with a plurality of magnetic elements 38. The magnetic elements 38 are mounted to the lower housing at intervals, so that the main control device 30 can be attached to magnetic metal surfaces such as an oven or a refrigerator.

To solve the problem in the existing technology that the battery of the probe 10 is “deadlocked” due to overdischarge, a voltage receivable by the first control module 15 in the probe 10 is greater than 2.5 V, and 3.7 V voltage control is preferably adopted. When a voltage of the first battery 14 is lower than 2.5 V, the first power management module 17 also controls the first bus switch Q4 to be opened. This configuration adopts a 3.7 V voltage platform, rather than a low-voltage farad capacitor commonly used in the existing technology, so that after the battery discharges for a period of time, the battery cannot continue to discharge, thereby avoiding overdischarge. In addition, the first power management module 17 adds 2.5 V voltage threshold control. When the battery voltage is lower than a safety threshold, a protection circuit automatically cuts off a discharging circuit, so that the battery enters a “sleep” state. When the probe 10 is placed back into the main control device 30 for charging, charging current is automatically activated, and normal charging is restored. Through this dual-protection control manner, the problem that the battery cannot be activated due to overdischarge is fundamentally solved, and long-term reliability of the product is significantly improved.

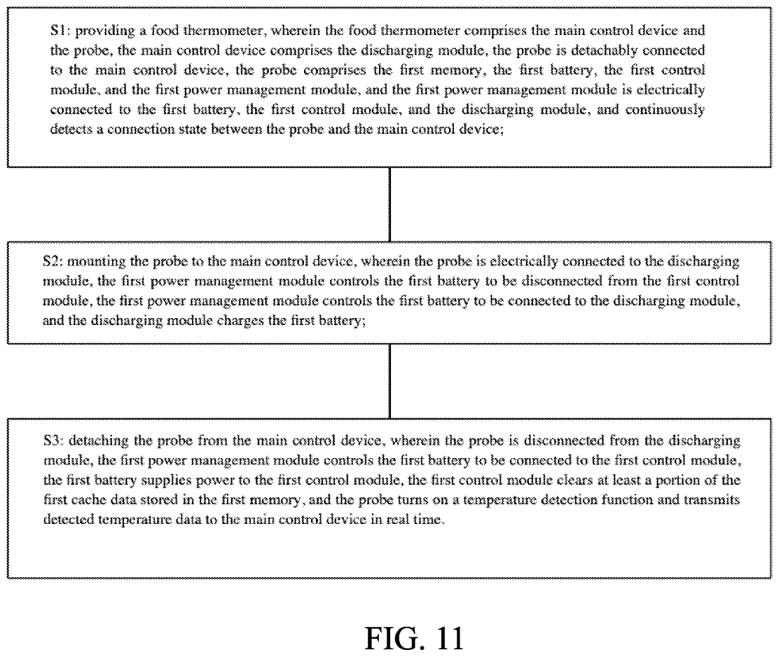

Referring also to FIG. 11, this embodiment provides a control method using the above food thermometer system 100, comprising the following steps:
S1: providing a food thermometer, wherein the food thermometer comprises the main control device 30 and the probe 10, the main control device 30 comprises the discharging module 37, the probe 10 is detachably connected to the main control device 30, the probe 10 comprises the first memory 151, the first battery 14, the first control module 15, and the first power management module 17, and the first power management module 17 is electrically connected to the first battery 14, the first control module 15, and the discharging module 37, and continuously detects a connection state between the probe 10 and the main control device 30;
S2: mounting the probe 10 to the main control device 30, wherein the probe 10 is electrically connected to the discharging module 37, the first power management module 17 controls the first battery 14 to be disconnected from the first control module 15, the first power management module 17 controls the first battery 14 to be connected to the discharging module 37, and the discharging module 37 charges the first battery 14; and
S3: detaching the probe 10 from the main control device 30, wherein the probe 10 is disconnected from the discharging module 37, the first power management module 17 controls the first battery 14 to be connected to the first control module 15, the first battery 14 supplies power to the first control module 15, the first control module 15 clears at least a portion of the first cache data stored in the first memory 151, and the probe 10 turns on a temperature detection function and transmits detected temperature data to the main control device 30 in real time.

Further, the first power management module 17 comprises the first bus switch Q4 and the first power manager U1. The first power manager U1, the first bus switch Q4, the first control module 15, and the discharging module 37 are electrically connected, and the first bus switch Q4 is disposed between the first power manager U1 and the first control module 15.

In S2, when the first power manager U1 detects that the probe 10 is electrically connected to the discharging module 37, the first power manager U1 controls the first bus switch Q4 to be opened, and the first battery 14 is disconnected from the first control module 15.

In S3, when it is detected that the probe 10 is disconnected from the main control device 30, the first power manager U1 controls the first bus switch Q4 to be closed, and the first battery 14 is electrically connected to the first control module 15.

Similarly, the main control device 30 comprises the second battery 32, the second control module 33, and the second power management module 35. The second control module 33 comprises the second memory 331, and the second power management module 35 is electrically connected to the second battery 32, the discharging module 37, and the second control module 33, respectively.

In S2, the method further comprises mounting the probe 10 to the main control device 30, and the second power management module 35 of the main control device 30 cuts off a power supply path between the second battery 32 and the second control module 33.

In S3, the method further comprises detaching the probe 10 from the main control device 30, and the second power management module 35 restores the electrical connection between the second battery 32 and the second control module 33, and the second control module 33 clears at least a portion of the second cache data stored in the second memory 331.

During the entire process, the system continuously monitors the voltage of the first battery 14. When the voltage of the first battery 14 is lower than 2.5 V, the first power management module 17 disconnects the power supply path between the first battery 14 and the first control module 15, so that the battery enters a protection state. When the probe 10 is re-mounted to the main control device 30 for charging, the protection circuit automatically restores, and the battery starts normal charging.

The food thermometer system capable of clearing cache data and the control method thereof provided by the present application have an ingenious structural design and a high degree of automation, effectively solve the storage space management and battery reliability problems that have long troubled the industry, have good industrial applicability and market prospects, and can be widely applied to fields such as household kitchens, outdoor barbecues, the catering industry, and food processing.

The term “at least one” mentioned in this application means that it can be one situation among them, or can be a coexistence of multiple situations. For example, “at least one of A, B, and C” includes all combinations such as A alone, B alone, C alone, A and B coexisting, A and C coexisting, and other arrangement combinations. Details are not explained one by one. The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A or B”, unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

The foregoing descriptions are merely embodiments of the present application. It should be noted herein that a person of ordinary skill in the art may make improvements without departing from the inventive concept of the present application, and these improvements all fall within the protection scope of the present application.

What is claimed is:

1. A food thermometer system capable of clearing cache data, comprising:
a main control device comprising a discharging module configured to provide electrical energy; and
a probe, wherein the probe is detachably connected to the main control device, the probe is electrically connected to the discharging module, the probe is configured to collect first cache data, and the probe comprises:
a first battery;
a first control module, wherein the first control module comprises a first memory, and the first memory is configured to store the first cache data; and
a first power management module;
the first power management module, the first control module, the first battery, and the discharging module are electrically connected;
wherein, when the probe is electrically connected to the discharging module, the first power management module controls the first battery to be disconnected from the first control module, and controls the first battery to be connected to the discharging module, the discharging module being configured to charge the first battery; and
when the probe is disconnected from the discharging module, the first power management module controls the first battery to be connected to the first control module, the first battery being configured to supply power to the first control module, and the first control module is configured to clear at least a portion of the first cache data stored in the first memory.

2. The food thermometer system capable of clearing cache data according to claim 1, wherein the first power management module comprises:
a first bus switch; and
a first power manager, wherein the first power manager, the first bus switch, the first control module, and the discharging module are electrically connected, and the first bus switch is disposed between the first power manager and the first control module;
wherein, when the first power manager detects that the probe is electrically connected to the discharging module, the first power manager controls the first bus switch to be opened, and the first battery is disconnected from the first control module; and
when the first power manager detects that the probe is disconnected from the discharging module, the first power manager controls the first bus switch to be closed, and the first battery is electrically connected to the first control module.

3. The food thermometer system capable of clearing cache data according to claim 1, wherein the probe further comprises:
a rod body made of a thermally and electrically conductive material; and
a handle made of a thermally insulating and electrically non-conductive material, the handle being fixedly connected to the rod body;
the handle and the rod body each have a hollow structure and together define a first accommodating space;
wherein the first memory, the first battery, the first control module, and the first power management module are accommodated in the first accommodating space.

4. The food thermometer system capable of clearing cache data according to claim 3, wherein the rod body has an overall elongated rod-like structure, and the rod body comprises:
a first end portion; and
a second end portion, wherein the handle is disposed between the first end portion and the second end portion, wherein the first end portion, the second end portion, and the first battery are electrically connected, and the discharging module is configured to charge the first battery through the second end portion and the first end portion.

5. The food thermometer system capable of clearing cache data according to claim 4, wherein the probe further comprises a temperature detection module accommodated in the first accommodating space, wherein the temperature detection module, the first battery, and the first control module are electrically connected to one another, and the temperature detection module is configured to collect the first cache data.

6. The food thermometer system capable of clearing cache data according to claim 4, wherein a side of the first end portion away from the handle is configured as a conical structure.

7. The food thermometer system capable of clearing cache data according to claim 4, wherein the main control device further comprises:
a housing, wherein the housing comprises an upper housing and a lower housing detachably connected to each other, the upper housing and the lower housing together define a second accommodating space, and the upper housing is provided with a plurality of connection holes;
the upper housing is provided with a mounting portion, wherein the probe is accommodated in the mounting portion;
a second battery;
a second control module; and
a second power management module, wherein the second power management module, the second control module, the second battery, and the discharging module are electrically connected to one another, and the second power management module, the second control module, the second battery, and the discharging module are all received in the second accommodating space.

8. The food thermometer system capable of clearing cache data according to claim 7, wherein the discharging module comprises:
a first electrode disposed at one of the connection holes, wherein the first electrode corresponds to the first end portion, and the first electrode passes through the one of the connection holes and is electrically connected to the first end portion; and
a second electrode disposed at another one of the connection holes, wherein the second electrode corresponds to the second end portion, and the second electrode passes through the another one of the connection holes and is electrically connected to the second end portion;
wherein the first electrode, the second electrode, and the second battery are electrically connected to one another.

9. The food thermometer system capable of clearing cache data according to claim 8, wherein the mounting portion is configured as a mounting groove formed by recessing from the upper housing in a direction toward the lower housing, and a shape of the mounting groove matches a shape of the probe.

10. The food thermometer system capable of clearing cache data according to claim 9, wherein the first electrode is configured as a clip spring, and the second electrode is configured as a spring plate; and when the probe is received in the mounting groove, the first electrode clamps the first end portion, such that the first electrode and the first end portion are electrically connected; and the second electrode abuts against the second end portion, such that the second electrode and the second end portion are electrically connected.

11. The food thermometer system capable of clearing cache data according to claim 10, wherein the second electrode is disposed on one side of the mounting groove, a side of the second end portion away from the handle is configured as a cylindrical structure corresponding to the second electrode, and a portion of the second end portion abutting against the second electrode is configured as a planar structure.

12. The food thermometer system capable of clearing cache data according to claim 9, wherein an extension groove is defined in a direction from the upper housing toward the lower housing, and the extension groove communicates with the mounting groove.

13. The food thermometer system capable of clearing cache data according to claim 8, wherein the second control module comprises a second memory, and the second memory is configured to store second cache data; wherein the discharging module further comprises a third electrode disposed at still another one of the connection holes and spaced apart from the first electrode, the third electrode corresponds to the first end portion, and the third electrode passes through the still another one of the connection holes and is electrically connected to the first end portion;
when the probe is placed in the mounting groove, the first end portion simultaneously contacts the first electrode and the third electrode, the first electrode and the third electrode are electrically short-circuited through the rod body, and the second power management module cuts off an electrical connection between the second battery and the second control module; and
when the probe is removed from the mounting groove, the second power management module restores the electrical connection between the second battery and the second control module, and the second control module is configured to clear at least a portion of the second cache data stored in the second memory.

14. The food thermometer system capable of clearing cache data according to claim 13, wherein the second power management module comprises:
a second bus switch; and
a second power manager, wherein the second power manager, the second bus switch, the second control module, the discharging module, and the second battery are electrically connected, and the second bus switch is disposed between the second power manager and the second control module;
wherein, when the second power manager detects that the first electrode and the third electrode are electrically short-circuited, the second power manager controls the second bus switch to be opened, and the second battery is disconnected from the second control module; and
when the second power manager detects that the first electrode and the third electrode are disconnected from each other, the second power manager controls the second bus switch to be closed, and the second battery is electrically connected to the second control module.

15. The food thermometer system capable of clearing cache data according to claim 13, wherein a length of the first end portion is greater than a length of the second end portion.

16. The food thermometer system capable of clearing cache data according to claim 13, wherein the third electrode is configured as a clip spring or a copper post.

17. The food thermometer system capable of clearing cache data according to claim 7, further comprising an external mobile device electrically connected to the main control device;
wherein the probe further comprises a first communication module, the first communication module is disposed in the first accommodating space and is electrically connected to the first control module; and
the main control device further comprises a second communication module, the second communication module is disposed in the second accommodating space and is connected to the second control module, and the second communication module is configured to receive temperature data transmitted by the first communication module and to send the temperature data to the second control module and to the external mobile device.

18. The food thermometer system capable of clearing cache data according to claim 17, wherein the main control device further comprises a display module disposed at a position where the connection holes are located, the display module is electrically connected to the second control module, and the display module comprises:
a display screen configured to display the temperature data and a battery level of the second battery; and
keys, wherein the second control module, the display screen, and the keys are electrically connected to one another.

19. The food thermometer system capable of clearing cache data according to claim 7, wherein the main control device further comprises a plurality of magnetic elements, and the magnetic elements are mounted to the lower housing at intervals.

20. The food thermometer system capable of clearing cache data according to claim 2, wherein a voltage receivable by the first control module is greater than 2.5 V, and when a voltage of the first battery is lower than 2.5 V, the first power management module also controls the first bus switch to be opened.
